(19) United States
(12) Patent Application Publication
(10) Pub. No.: US 2005/0027824 A1
(43) Pub. Date: Feb. 3, 2005

(54) Interprocessor communication protocol providing guaranteed quality of service and selective broadcasting

(76) Inventor: Charbel Khawand, Miami, FL (US)

Correspondence Address: MOTOROLA, INC., 1303 EAST ALGONQUIN ROAD, IL01/3RD, SCHAUMBURG, IL, 60196, US

(21) Appl. No.: 10/631,043

(22) Filed: Jul. 29, 2003

(51) Int. Cl. G06F 15/16

(52) U.S. Cl. 709/219

(57) ABSTRACT

An InterProcessor Communication (IPC) Protocol network (100) includes at least one IPC client (102) and an IPC server (108). The IPC protocol allows for the IPC client (102) to register with the IPC server (108) which will provide the means for the two to communicate freely without any limitations on what software architectures, operating systems, hardware, etc. each depend on. The IPC protocol in one embodiment of the invention allows for components to dynamically request different Quality of Service (QoS). In another embodiment, an IPC node can selectively broadcast a message to nodes which are selected by the sender.

### TECHNICAL FIELD

This invention relates in general to the field of electronics, and more specifically to an InterProcessor Communication (IPC) protocol/network providing a guaranteed Quality of Service (QoS) and a selective broadcasting feature.

### BACKGROUND

Most electronic systems include a number of networked elements (components) such as hardware and software that form the system. In most systems there is a layer responsible for communication between the different components that form a networked element as well as between the different networked elements themselves. This layer is typically referred to as the InterProcessor Communication (IPC) layer.

Several protocols have been introduced in the last few years to deal with interprocessor communications. One example of an IPC product is a PCI AGP Controller (PAC) that integrates a Host-to-PCI bridge, Dynamic Random Access Memory (DRAM) controller and data path and an Accelerated Graphics Port (AGP) interface. Another example of an IPC product is the OMAP™ platforms. Neither of these platforms provide design flexibility at the lower level component or channel levels (hardware level).

The PAC platforms for example, are closed architectures and are embedded into the Operating System's TAPI layer, with the IPC code not being accessible to developers. Therefore, these platforms do not extend to the component levels and do not allow for dynamic assignment of IPC resources, do not allow components to determine service capabilities, and do not provide for multi-node routing.

One of the main issues with real-time processing is the need for guaranteed Quality of Service (QoS) for all of the participating software components operating on different Mobile Applications (MAs). For example, a portable radio communication device can comprise a Motorola, Incorporated iDEN™ Wide-area Local Area Network (WLAN) baseband MA with a PCS Symbian based application processor.

Software components in general are unaware of what QoS is and how it can be guaranteed. With current prior art systems, components that need a certain level of guaranteed hardware performance have to be tailored differently in view of the different hardware platforms. If an individual component in a tightly coupled system needs to guarantee a certain hardware performance level (e.g., certain amount of data bandwidth, etc.), it typically needs to tailor its QoS requirements in such a way that it forces the IPC to become platform specific. This of course is a major problem in the area of device portability (reuse).

Another problem experienced by prior art IPC systems is the problem of pre-assignment. Pres-assignment forces each software component to know in advance of compiling how much data bandwidth it requires for sending and receiving data on the IPC. Pre-assignment of IPC channels forces all of the MAs to have the same exact channel assignment on the IPC which is not a desirable solution in today's market. Pre-assignment also forces components to block a channel and its resources although the component may not be using the channel resources, which causes additional inefficiencies. Given the above, a need thus exists in the art for an IPC protocol that can provide a solution to some of these shortcomings in the prior art.

### BRIEF DESCRIPTION OF THE DRAWINGS

The features of the present invention, which are believed to be novel, are set forth with particularity in the appended claims. The invention may best be understood by reference to the following description, taken in conjunction with the accompanying drawings, in the several figures of which like reference numerals identify like elements, and in which:

FIG. 1 shows a diagram of an IPC network in accordance with an embodiment of the invention.

FIG. 2 shows an IPC stack in accordance with an embodiment of the invention.

FIG. 3 shows an IPC component IPC assignment in accordance with an embodiment of the invention.

FIG. 4 shows the main IPC tables in accordance with an embodiment of the invention.

FIG. 5 shows a diagram of channel allocation in accordance with an embodiment of the invention.

FIG. 6 shows a diagram highlighting the steps involved during an IPC client initialization routine in accordance with an embodiment of the invention.

FIG. 7 shows another diagram highlighting the steps involved during an IPC client initialization in accordance with an embodiment of the invention.

FIG. 8 shows a diagram highlighting the first level of IPC encapsulation in accordance with an embodiment of the invention.

FIG. 9 shows a diagram highlighting the steps taken during IPC component initialization in accordance with an embodiment of the invention.

FIG. 10 shows a chart highlighting the steps taken during component initialization in accordance with an embodiment of the invention.

FIG. 11 shows the transfer of IPC data between an IPC client and an IPC server in accordance with an embodiment of the invention.

FIG. 12 shows a diagram of an IPC data header in accordance with an embodiment of the invention.

FIG. 13 shows a diagram of the steps taken during an IPC data request in accordance with an embodiment of the invention.

FIG. 14 shows an IPC network in accordance with an embodiment of the invention.

FIG. 15 shows an electronic device such as a radio communication device in accordance with an embodiment of the invention.

FIGS. 16 and 17 show diagrams of outbound streaming in accordance with an embodiment of the invention.

FIG. 18 shows a diagram of inbound streaming in accordance with an embodiment of the invention.

FIG. 19 shows a diagram highlighting a QoS procedure in accordance with an embodiment of the invention.

FIG. 20 shows a diagram highlighting component to component messaging in accordance with an embodiment of the invention.

FIG. 21 shows a diagram highlighting component to component messaging were the components are located on different processors in accordance with an embodiment of the invention.

FIG. 22 shows an IPC network highlighting the filtering tables in accordance with an embodiment of the invention.

FIG. 23 shows a diagram of a filtering table in accordance with an embodiment of the invention.

FIG. 24 shows an IPC network providing for selective broadcasting of messages in accordance with an embodiment of the invention.

### DETAILED DESCRIPTION OF THE PREFERRED EMBODIMENT

While the specification concludes with claims defining the features of the invention that are regarded as novel, it is believed that the invention will be better understood from a consideration of the following description in conjunction with the drawing figures.

In accordance with an embodiment of the invention, components coupled to the IPC network can dynamically request different QoS levels. Although the QoS is guaranteed in terms of priority and data rates, it is not limited to these parameters alone; the QoS technique can take into account other QoS factors. The advantages of the IPC to guarantee QoS allows for architecture abstraction from the platforms as well as component portability between different MAs.

The selective broadcasting feature of the present invention allows an IPC node to send a message to select IPC nodes coupled to the IPC network. The network uses a filter table so that an IPC server can send the broadcast message to the nodes that are selected by the sender. The filter table can also be dynamically updated by the IPC nodes through the IPC link. In accordance with an embodiment of the invention, the selective broadcasting feature allows for a dynamic method by which software components can communicate with other software components on different MAs. This allows the MA not to have to be configured in terms of a fixed set of dedicated IPC bandwidth and channels as is the case with some prior art systems. The IPC stack and the hardware coupled to the stack are also abstracted such that components can choose different links to communicate as they need them. The IPC network will first be described followed by a discussion of the QoS and selective broadcasting features of the present invention.

The IPC of the present invention provides the support needed for different processors operating within the IPC network to communicate with each other. For example, in a dual processor radio architecture for use in a radio communication device that includes an Application Processor (AP) and a Baseband Processor (BP), the IPC provides the support needed for the processors to communicate with each other in an efficient manner. The IPC provides this support without imposing any constraints on the design of the AP or BP.

The IPC allows any processor that adopts the IPC as its inter-processor communication stack to co-exist together and operate as if the two were actually running on the same processor core sharing a common operating system and memory. With the use of multiple processors in communication devices becoming the norm, the IPC of the present invention provides for reliable communications between the different processors.

The IPC hardware provides the physical connection that ties together the different processors to the IPC network. In one embodiment of the invention, data packets are transported between the different hosts asynchronously. Processors that are connected to the IPC network have their physical and logical addresses statistically or dynamically assigned (e.g., IPC addresses). Also, since data packets can flow in any direction within the IPC network in one embodiment of the invention, the packets carry a destination address of the processor that they are trying to reach.

Packets are also checked for errors using conventional Cyclic Redundancy Check (CRC) techniques. Although the network activities of the IPC network of the present invention may have some similarities to those found on an internet network that uses IP transport layers such as a Transmission Control Protocol/Internet Protocol (TCP/IP) network, the IPC of the present invention is not divided into smaller networks with gateways as in a TCP/IP network.

Referring now to FIG. 1, there is shown an IPC network 100 in accordance with an embodiment of the invention. The IPC network 100 includes a plurality of IPC clients 102-106, and an IPC server 108 coupled to the IPC clients 102-106 using different IPC physical links such as shared memory 110, Universal Asynchronous Receiver/Transmitter (UART) 112 and Universal Serial Bus (USB) 114 as some illustrative examples. It should be noted that with the IPC of the present invention, an IPC client 102-106 can negotiate with the current IPC server 108 to switch roles. If an IPC client 102-106 negotiates to become the IPC server and becomes the new IPC server, all of the remaining IPC clients are instructed to change the IP address of the server given the change in the IPC server.

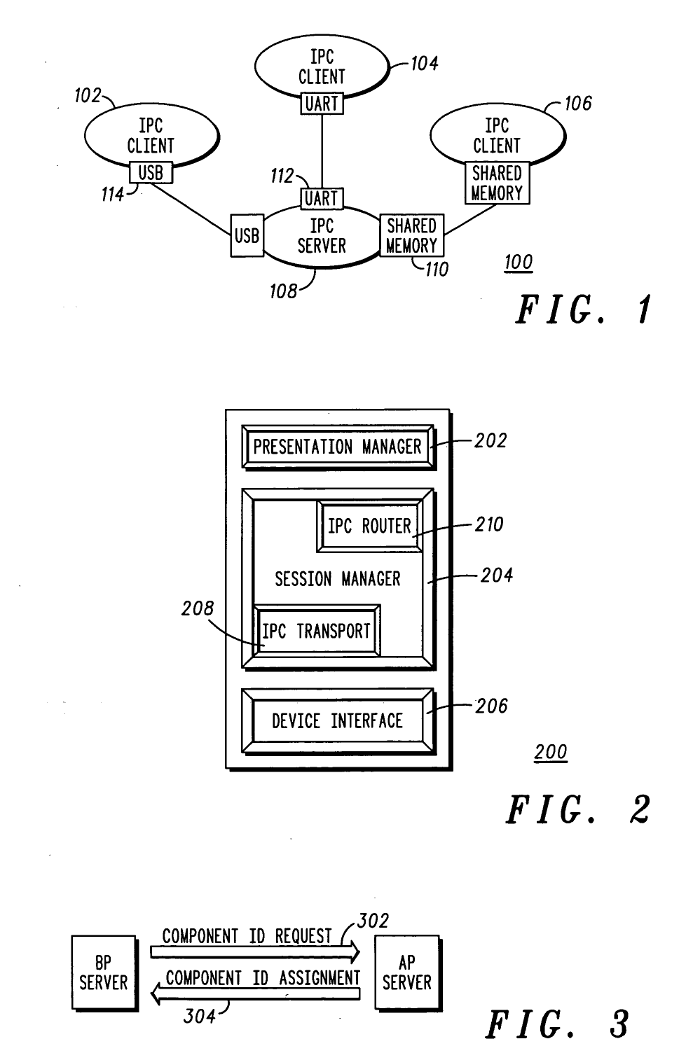

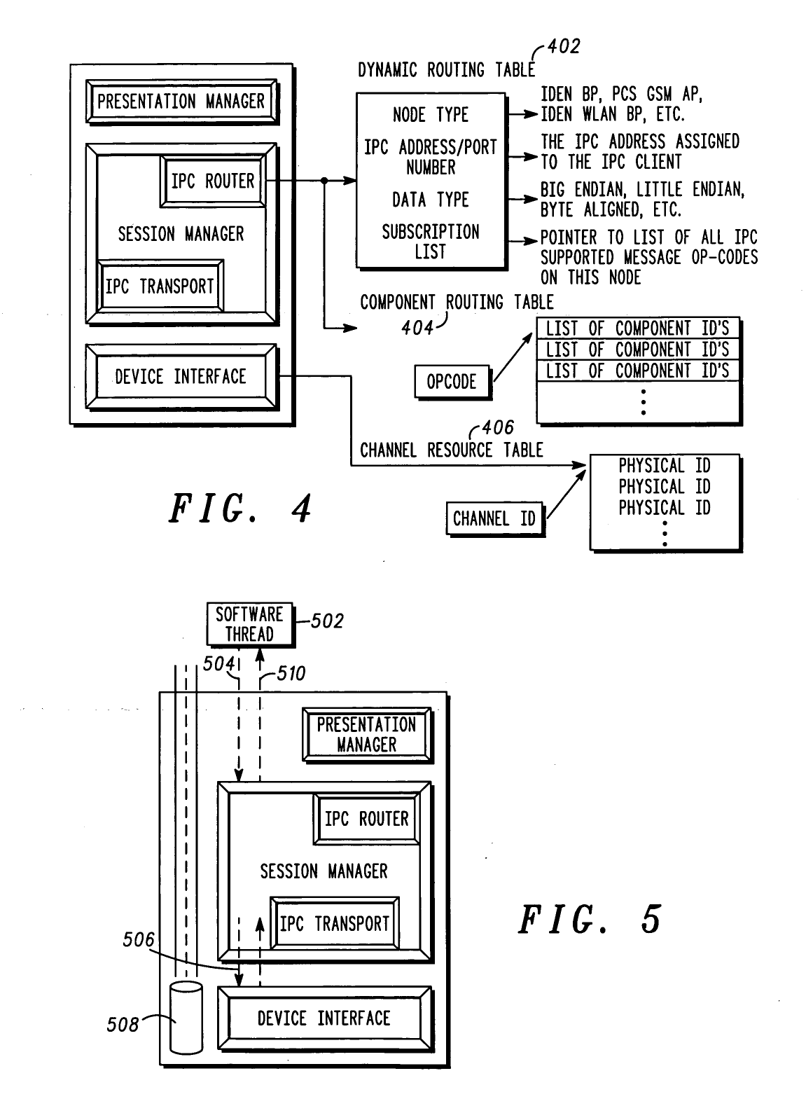

In FIG. 2, there is shown an IPC stack 200 of an IPC server 108 (or IPC clients 102-106) in accordance with an embodiment of the present invention. The IPC stack 200 is designed to be integrated under an Operating System (OS) and to provide support for the inter-processor communication needs of component traffic. The IPC stack is composed of the following 3 main layers:
(1). IPC Presentation Manager (202)—this layer is used to translate different data types between different system components (e.g., software threads).
(2). IPC Session Manager (204)—this layer is a central repository for all incoming/outgoing IPC traffic between the IPC stack and all of the system components. The IPC session manager 204 has several functions: assignment of component IDs for participating IPC components; deciding if the IPC data needs to be encapsulated; routing of IPC data, termination of IPC traffic; place holder for IPC processors; providing IPC addresses, assigning and authenticating IPC clients, etc.
   IPC Transport Layer (208)—located within the IPC session manager (layer) 204, the IPC transport layer 208 provides a very basic cyclic redundancy check for the purpose of transporting the IPC data between the different processors. In addition, the IPC transport layer 208 is responsible for routing IPC messages to their final destinations on the IPC network 100. The routing function of the transport layer is enabled only on IPC servers.
   IPC Router Block (210)—transports the IPC data to a destination component (not shown). Incoming IPC messages carry among other things, the originator component ID and the IPC message opcodes such as Audio and Modem. Note that in accordance with an embodiment of the invention, a unique opcode is assigned to each component/software thread (see for example 502 in FIG. 5), such as Audio and Modem that is coupled to the IPC network. The IPC session manager 204 relies on the router block 210 to send the IPC data to the right component(s).
(3). Device Interface Layer (206)—is responsible for managing the IPC physical-to-logical IPC channels. Its main function is to abstract the IPC hardware completely so that the stack IPC becomes hardware independent. The device interface layer 206 manages the physical bandwidth of the IPC link underneath to support all of the IPC logical channels. In the incoming path, the device interface layer 206 picks up data from different physical channels 110-114 and passes them up to the rest of the IPC stack. On the outgoing path, the device interface layer 206 manages the data loading of the IPC logical channels by sending them onto the appropriate physical channels. The device interface layer 206 also handles concatenating IPC packets belonging to the same IPC channel before sending them to the IPC hardware. Channel requirements are pre-negotiated between the IPC session manager 204 and the IPC device interface layer 206. The device interface layer 206 provides for hardware ports which in turn provide a device interface to an IPC client 102-106.

Referring to FIG. 3 there is shown an IPC component ID assignment routine. In step 302, any new component wishing to participate in an IPC communication must do so by first requesting an IPC Identification Number (ID) in step 302 from its IPC session manager (e.g., like session manager 204). The local session manager (e.g., session manager located in client that the component is coupled to) will then alert the IPC server's session manager of the new IPC components and a component ID assignment will be provided in step 304. In accordance with an embodiment of the invention, the component IDs are dynamic and can be reassigned by the session manager (e.g., the server's session manager). The main IPC server location will most likely be on the main AP. Each IPC node will have a unique IPC node ID and the session manager will keep in its database the following information for each participating IPC node:
IPC Node Type: For example, a particular BP or AP, a Wireless Local Area Network (WLAN) AP, etc.
IPC address: The IPC address of the IPC node.
Data Type: The data type of the IPC node.
Opcode list: This is a list of all the IPC message opcodes that the components have subscribed to.
Component IDs: List of all the component IDs.

Referring now to FIG. 4, there is shown an IPC stack along with all of the main IPC tables. The Dynamic routing table 402 includes the Node Type, IPC address/Port # information, Data Type and Subscription list. The component routing table 404 includes the information linking the Opcode information and all of the components subscribed to each particular Opcode. Finally, the Channel Resource table 406 includes a linking of each Channel ID with a list of physical channel IDs.

In FIG. 5, there is shown a block diagram of how the IPC stack provides an IPC channel for a component such as a software thread (e.g., Audio, etc.) in accordance with an embodiment of the invention. Component 502 first requests an IPC channel in step 504. The session manager shown in FIG. 5, negotiates the component's request with the Device Layer in step 506 using a defined API. The Device layer (Device Interface) then requests hardware resources, such as a data channel 508. In response to the request, the session manager shown in FIG. 5 grants an IPC channel to the requester in step 510. The component 502 next sends its data on the assigned channel 508. The device layer then forwards the data to the IPC network. The mapping of the logical to physical channel IDs is the function of the IPC device interface.

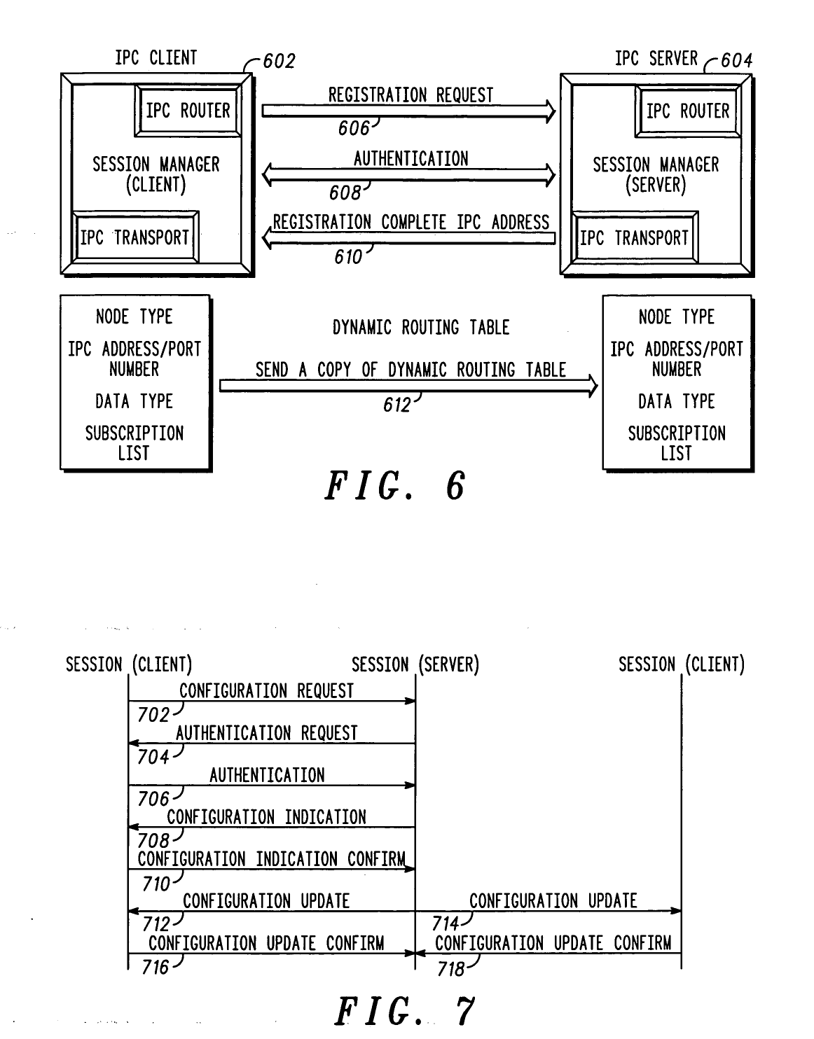

Referring now to FIG. 6, the first step in IPC client initialization is sending a registration request (step 606) between the IPC client 602 and the IPC server 604. The IPC server 604 then authenticates the request with the IPC client 602 in step 608. This is followed by sending an IPC address to the IPC client and completing the registration in step 610. The IPC client's session manger sends a copy of its dynamic routing table to the IPC server in step 612.

More detailed steps taken during the IPC client initialization process are shown in FIG. 7. The client session manager (shown in table as Session (client)) sends a configuration request to the IPC server's session manager (shown in table as Session (Server)) in step 702. In step 704, authentication is requested by the IPC server's session manager. Authentication between the IPC client and IPC server is then carried out in step 706.

The parameters in the configuration request include the node type and the data type. The session server in response to the configuration request in step 702 assigns the requestor an IPC address. It also sets up a dynamic routing table for the requestor if one does not exist. It then sends the requester a configuration indication as in step 708. The configuration indication parameters include the IPC address of the server and the newly assigned IPC address of the client.

In response to receiving the configuration indication, components attached to the session client can request control/data from the client's session manager. The Session client then sends a configuration indication confirm message to the session server in step 710. The “configuration indication confirm” message has no parameters. Upon receiving the configuration indication confirm message in step 710, the session server can initiate IPC streams to the newly configured session client. The session server then sends configuration update messages to the session clients in steps 712 and 714. This causes both session clients shown in FIG. 7 to update their respective dynamic routing tables (not shown) and send a configuration update confirm message to the session server in steps 716 and 718. Upon receiving the configuration update confirm messages, the session server makes sure all of the IPC participants have been updated.

When a packet is received by an IPC session manager, it comes in the form of data that includes the source component ID, the destination ID, a channel ID and the type of BP or AP. The IPC session manager will add the destination component ID in the event that the destination ID is not inserted. The IPC session manager will also insert an IPC address. It is the IPC session manager that discovers the destination ID based on the message opcode received. The destination ID is based on a lookup table. This lookup table is updated dynamically each time a component subscribes to a new IPC message opcode (e.g., an audio component subscribes to audio messages by sending a request to the IPC session manager).

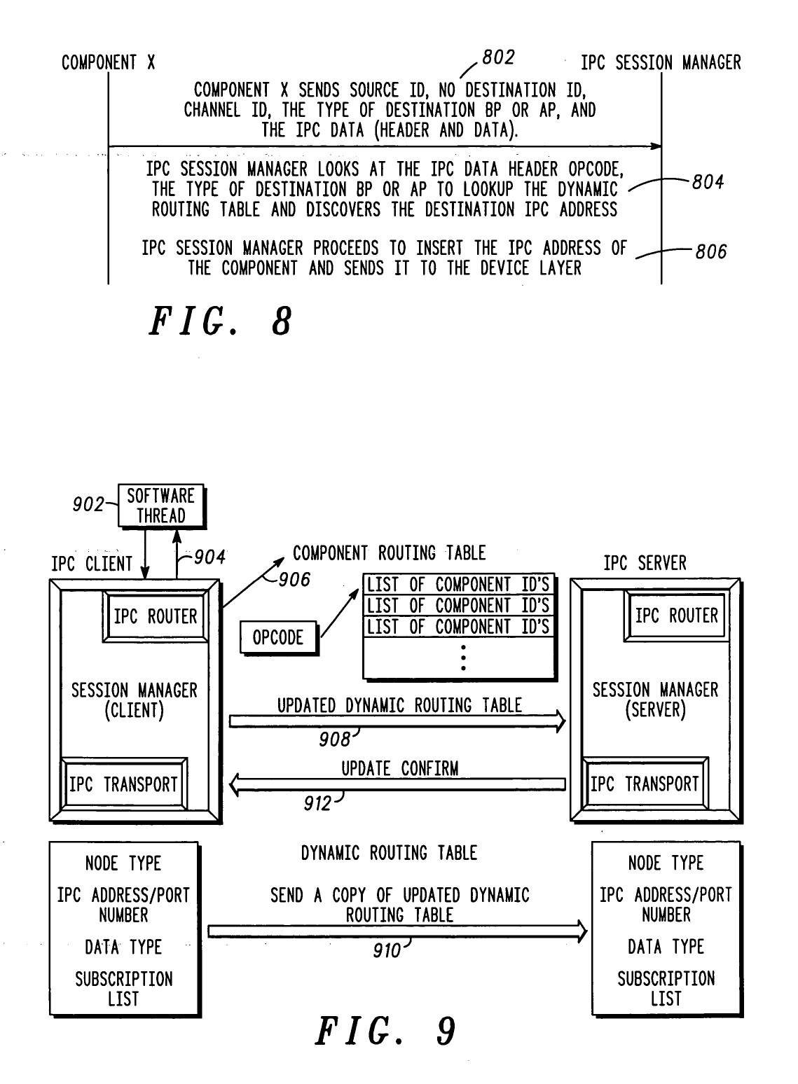

In FIG. 8 there is shown a sequence of events during a general destination ID discovery sequence between a component and its IPC session manager in accordance with an embodiment of the invention. In step 802, the component sends its source ID (but no destination ID), the type of the destination BP or AP and the IPC data which includes a header and data. In step 804, the IPC session manager looks at the IPC data header opcode and the type of destination BP or AP, in order to lookup the corresponding dynamic routing table and find the correct destination address. In step 806, the IPC session manager inserts the IPC address of the component and sends it down to the device layer.

In FIG. 9, typical steps taken during an IPC component initialization are shown. Once the BP has been configured by the IPC server shown in FIG. 9, it allows components such as component 902 to subscribe to different services. Components will subscribe themselves to functions such as Audio, Video, etc. in step 904. The component subscription information is then sent to the IPC session manager for component ID creations (if an ID is not assigned yet) and creation or updating of the dynamic routing table for a particular IPC address (step 906). In step 908, the session manager updates the IPC server with the information from step 906. A confirmation of the dynamic routing table is sent in step 912 by the IPC server to the IPC client. Once the server is alerted, new dynamic routing table updates are broadcast to all participating processors in step 910.

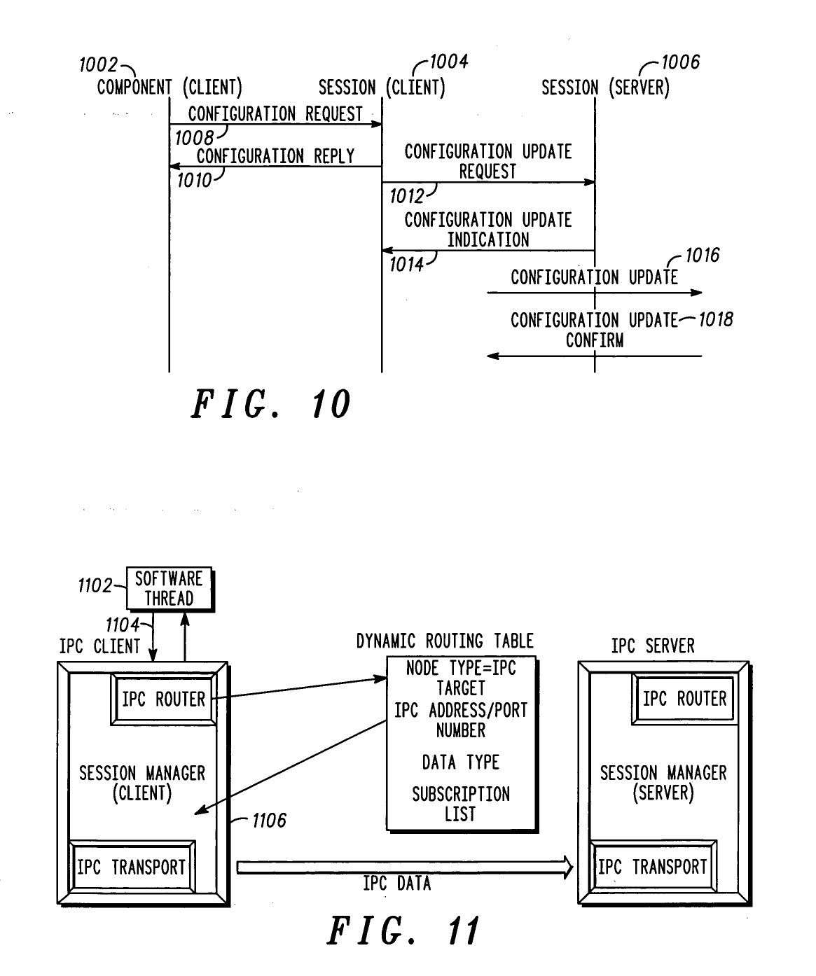

The same component initialization process is shown between a component (client) 1002, a session (client) also known as a client session manager 1004 and the session (server) also known as the server session manager 1006 in FIG. 10. In step 1008, a component configuration request is sent by the component (client) 1002. In response to the request, the client session manager 1004 negotiates a logical channel with its device layer (not shown). The client session manager 1004 also assigns a component ID and adds the new opcode list to its dynamic routing table (not shown). In step 1010, the client session manager 1004 sends a configuration reply which includes the component ID and the channel ID as parameters. In response to the configuration reply, the component (client) 1002 receives its ID and channel ID from the client's session manager 1004.

Once the client session manager 1004 replies in step 1010 to the configuration request in step 1008, the client session manager 1004 sends a configuration update request to the session server 1006 (step 1012). The parameters for the configuration update request are any new changes that have been made in the dynamic routing table. The session manager updates the dynamic routing table for that IPC address. In step 1016, the server session manager 1006 then sends all the IPC clients a configuration update, while it sends the IPC client a configuration update indication in step 1014. The server's session manager 1006 makes sure the IPC server has updated its routing table with the changes that were sent.

In the configuration update message of step 1016 which includes the dynamic routing tables as a parameter(s), the session server 1006 updates the dynamic routing tables and sends a configuration update confirm message in step 1018. The session server 1006 then makes sure all of the IPC participants have been updated.

The IPC session manager determines the routing path of incoming and outgoing IPC packets. The route of an outgoing packet is determined by the component's IPC address. If the destination address is found to be that of a local processor, a mapping of the IPC to the Operating System (OS) is carried out within the session manager. If the destination address is found to be for a local IPC client, the packet is sent to the IPC stack for further processing (e.g., encapsulation). Note that if the destination component is located on the same processor as the component sending the IPC packet, no encapsulation is required and the packet gets passed over through the normal OS message calling (e.g., Microsoft Message Queue, etc.). In this way components do not have to worry about modifying their message input schemes. They only need to change their message posting methodologies from an OS specific design to an IPC call.

For incoming packets, if the destination address of the message is not equal to the IPC server's, the incoming packets are routed to the proper IPC client. The routing of incoming packets is handled by the session manager of the IPC server. Otherwise, the message is forwarded to the right component or components depending on whether or not the component destination ID is set to a valid component ID or to 0XFF.

The IPC router block transports the IPC data to the destination component. Incoming IPC messages carry among other things, the originator component ID and the IPC message opcodes such as those for Audio, Modem, etc. The IPC session manager relies on its component routing table to send the IPC data to the right component(s). Both the dynamic routing table and the component routing table are updated by the IPC server/client.

During power-up, each component must register itself with its session manager to obtain an IPC component ID. In addition, it must also subscribe to incoming IPC messages such as Audio, Modem, etc. This information is stored in the component routing table for use by the IPC session manager.

When a component 1102, as shown in FIG. 11, sends its data request to the IPC session manager as in step 1104, a check is made on the destination IPC node (e.g., the BP). If the IPC node does not support the IPC message opcode, an error reply is returned to the component 1102. In addition to the error reply, the IPC session manager returns an update of all the IPC nodes that are capable of receiving that particular opcode. It is up to the component to decide to which of the IPC node(s) it will redirect the message. The IPC session manager 1106 will proceed to encapsulate the data with the IPC header information before the data is sent on the IPC network if the session manager determines that the destination component is located in the IPC network but not in the local processor.

In FIG. 12, there is shown an IPC data header 1202 in accordance with an embodiment of the invention. The header includes the source and destination IPC addresses, source port, destination port provided by the IPC router, the Length and checksum information provided by the IPC transport and the source IPC component and Destination IPC component provided by the session manager. The Message opcode, message length and IPC data are provided by the component 1204.

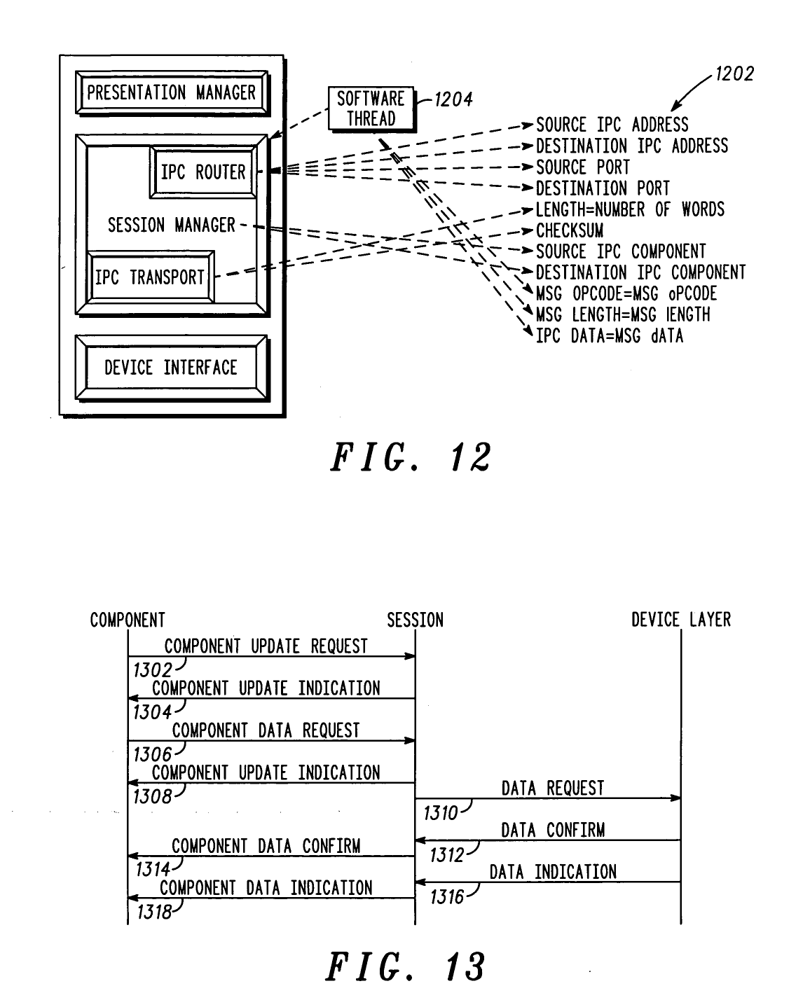

A typical IPC data request in accordance with an embodiment of the invention is shown in FIG. 13. In step 1302, the component sends an update request. The component update parameters include the node type and opcode. The component searches for Node types that support its destination opcode. If the Node type is equal to 0×FF, the session manager proceeds to send the component information to all the node tables for all IPC participants. If the opcode field is equal to 0×FF, the session manager proceeds to send the component the opcode list belonging to the specified Node type. On the other hand, if the opcode has a specific value, the session manager proceeds to send the component a true or false value corresponding to whether the Node type supports or does not support that particular opcode.

In step 1304, the component update indication is sent to the component. If the node type is equal to 0×FF, the node tables are returned to the component. If the opcode field is equal to 0×FF, the list of opcodes is returned to the component. However, if the opcode is a specific value, a true or false message is returned. In step 1306, a component data request is made. The parameters for the component data request include the node type, the IPC message opcode, the IPC message data, the channel ID and the component ID. In a component data request, the session manager checks the node type to determine whether the opcode is supported. If the node type does not support the opcode, a component update indication is sent in step 1308. If however, the node type supports the opcode, a data request is sent to the device layer in step 1310. The data request parameters include the IPC message, the channel ID and the IPC header.

The device layer schedules to send the data request message based on the channel ID. The device layer selects the IPC hardware based on the port # header information. Once the data is committed, a data confirm message is sent to the session manager in 1312. In step 1314, the session manager proceeds to send a component data confirm message to the component. The component can wait for the confirmation before sending more IPC messages. Once a data confirm is received, the component can proceed to send the next IPC message.

In step 1316, the device layer sends a data indication message including IPC message data and an IPC header. The session manager checks the destination IPC header of the message, and if different from the local IPC address, the session manager sends (routes) the message to the right IPC node. In step 1310, the session manager sends a data request to the device layer with a reserved channel ID. The session manager checks the destination component ID, and if it is equal to 0×FF, routes the message to all the components subscribed to that opcode. In step 1318, the session manager sends a component data indication message and the component receives the IPC data.

The IPC stack uses a reserved control channel for communication purposes between all participating IPC nodes. On power-up, the IPC server's session manager uses this link to broadcast messages to IPC clients and vice versa. During normal operations, this control channel is used to carry control information between all APs and BPs.

In FIG. 14, there is shown the control channels 1402-1406 located between the IPC stacks and the IPC hardware. Control channel information 1408 is also transmitted along with data packets 1410 when sending data between different IPC hardware. An IPC client broadcasts its configuration request initially on the IPC control channel. The IPC server receives the broadcast and responds with an IPC address for that client. This IPC address becomes associated with the dynamic routing table for that particular processor (AP or BP).

IPC Application Program Interfaces (APIs)

Below are listed some of the APIs for the IPC protocol of the present invention.

1). Component Interface to the IPC Session Manager:

CreateComponentInst( )

Creates a component database in the IPC session manager. Information such as component data types (Big Endian vs. little Endian) and subscription to message opcodes are used in the dynamic data routing table belonging to an IPC address.

OpenChannelKeep( )

Open an IPC channel and if one is available, a ChannelGrant( ) is issued. The channel is reserved until a CloseChannel( ) is issued. Components send QoS requests to the IPC session Manager. The IPC channel assigns a component ID if one is not yet assigned (e.g. ChannelGrant( )).

OpenChannel( )

Open an IPC channel and if one is available, a ChannelGrant( ) is issued. The parameters are the same used for the OpenChannelKeep( ) primitive.

OpenChannelWThru( )

Open an IPC channel and if one is available, a ChannelGrant( ) is issued. This is a request for a write thru channel signifying that encapsulation be turned off on this channel (e.g. Non UDP AT commands).

CloseChannel( )

Request that an IPC channel be closed. The Component no longer needs the channel. The resources are then freed.

ChannelGrant( )

A channel is granted to the requester. The Channel IDs are assigned by the IPC session manager if one is not yet assigned.

ChannelError( )

A channel error has occurred. The channel is closed and the requestor is notified.

ChannelDataIndication( )

The requestor is alerted that data on a channel is to be delivered. This message is sent by the IPC presentation manager to the target component. This also includes control channel data.

DataChannelRequest( )

The requestor wants to send data on an opened channel. This also includes control channel data.

ChannelClose( )

Request that an IPC channel be closed. A channel inactivity timer expired and the Channel associated with the timeout is closed. This could also be due to channel error.

2). IPC Session Manager to/from IPC Device Interface

OpenChannel( )

Open a logical IPC channel and if one is available, a ChannelGrant( ) is issued. The IPC session manager sends channel priority requests to the IPC device interface manager.

CloseChannel( )

Request that an IPC logical channel be closed. A component decides that it no longer requires the channel.

ChannelGrant( )

A logical channel is granted to the requester.

ChannelError( )

A channel error has occurred (e.g. CRC failure on incoming data or physical channel failure).

ChannelDataIndication( )

The requestor is alerted that data on a channel is to be delivered.

DataChannelRequest( )

The requester wants to send data on the logical channel.

ChannelClose( )

Request that an IPC channel be closed. A channel inactivity timer expired and the Channel associated with the timeout is closed. This could also be due to channel error.

3). IPC Session Manager to IPC Presentation Manager

ChannelDataIndication( )

The requester is alerted that data on a channel is to be delivered. The information is to be forwarded to the target component with the correct data format.

4). IPC Hardware/IPC Stack Interface

OpenChannel( )

Open a physical IPC channel and if one is available, a ChannelGrant( ) is issued. The IPC session manager sends channel priority requests to the IPC Hardware.

CloseChannel( )

Request that an IPC physical channel be closed. The component no longer requires the channel.

ChannelGrant( )

A physical channel is granted to the requestor.

ChannelError( )

A channel error has occurred (e.g. CRC failure on incoming data or physical channel failure).

ChannelDataIndication( )

The requester is alerted that data on a channel is to be delivered.

DataChannelRequest( )

The requestor wants to send data on the physical channel.

ChannelClose( )

Request that an IPC channel be closed. A channel inactivity timer expired and the Channel associated with the timeout is closed. This could also be due to channel error.

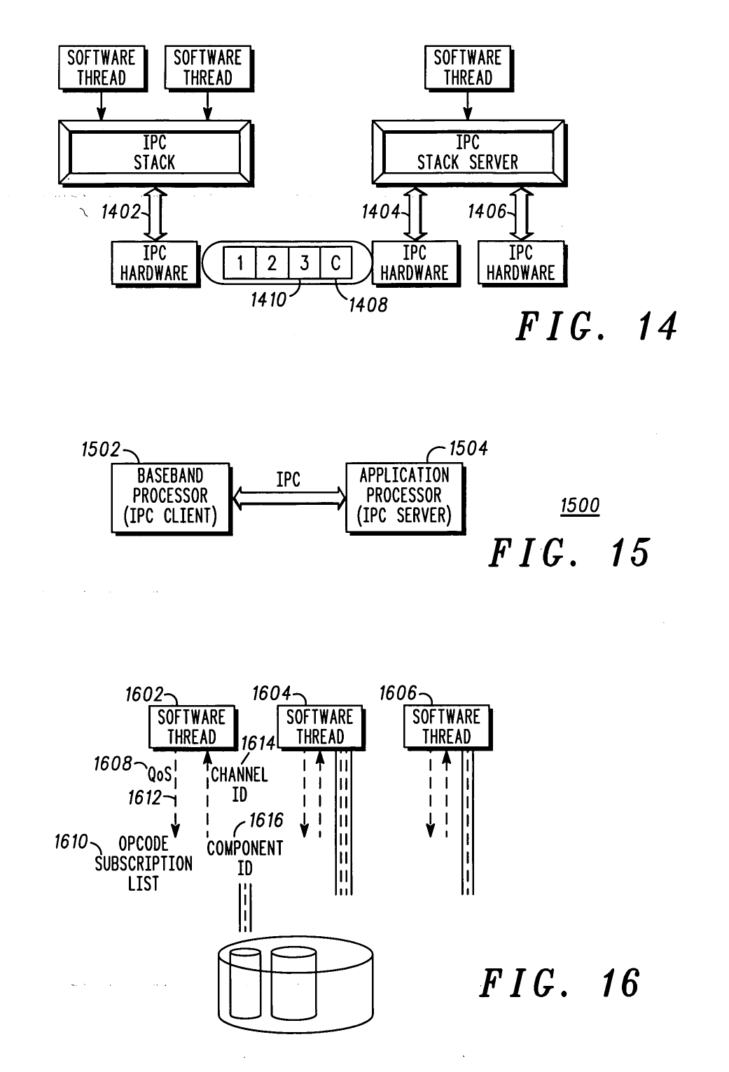

In FIG. 15, there is shown a block diagram of an electronic device such as a radio communication device (e.g., cellular telephone, etc.) 1500 having a baseband processor (BP) 1502 and an application processor (AP) 1504 communicating with each other using an IPC network. The IPC protocol of the present invention provides for communications between multiple processors in a system such as a communication device. The IPC allows for a Mobile Application (MA) client (e.g., iDEN™ WLAN) to register with a MA server such as a Personal Communication System (PCS) application, and will provide the means for the two MAs to communicate freely without any limitations on what software architectures, operating systems, hardware, etc. each depend on within its own MA.

Referring now to FIG. 16, there is shown three components such as software threads, 1602, 1604 and 1606, and how they establish outbound streaming. Software thread 1602 for example, sends a request 1612 for a predetermined QoS 1608 and submits its opcode subscription list 1610. In return, software thread 1602 is assigned a channel ID 1614 and a component ID 1616 in response message 1618. Components such as software threads 1602, 1604 and 1606 in accordance with an embodiment of the invention are assigned IPC hardware resources depending on their requirements. The components 1602, 1604 and 1606 can be dynamically installed or uninstalled depending on the system requirements.

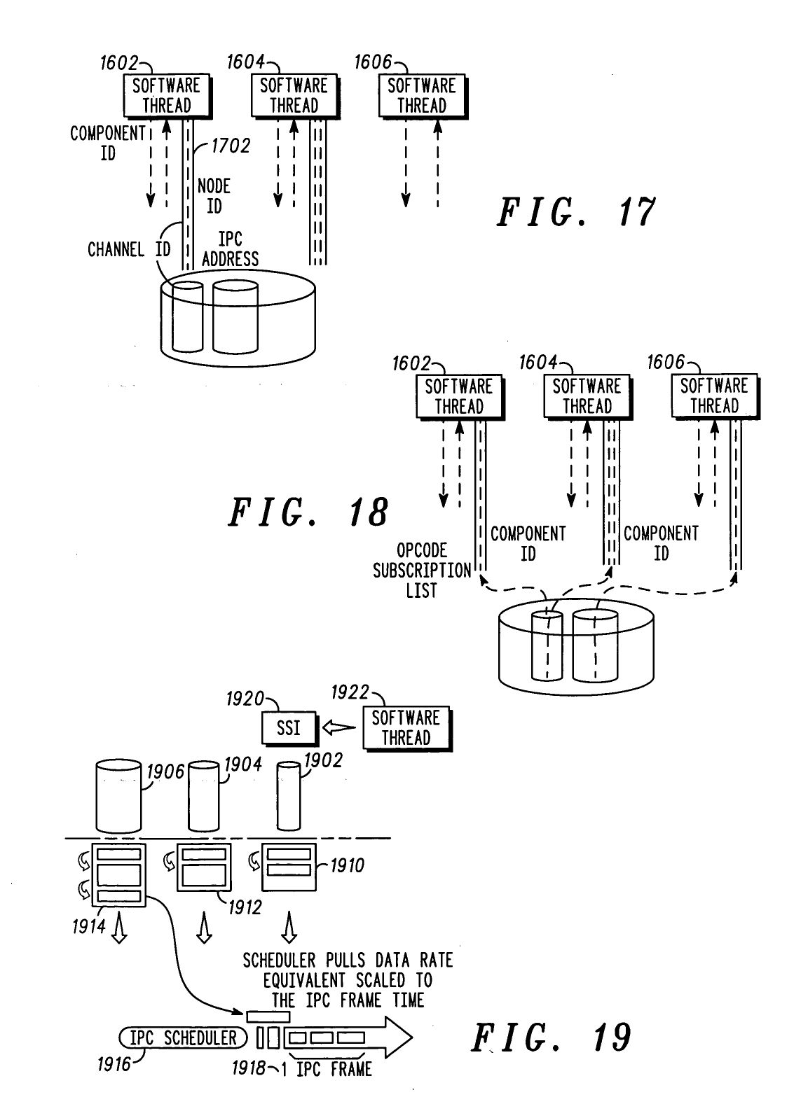

In FIG. 17, components 1602, 1604 and 1606 send IPC data on their assigned channels such as channel 1702 for software thread 1602. The components 1602, 1604 and 1606 submit their data along with a target IPC node, although components can also broadcast their messages to all IPC nodes when no node is specified. The components 1602, 1604 and 1606 do not need to know the destination components IDs, nor their associated channels or their IPC address. Regarding inbound streaming, message opcodes identify components. For example, in FIG. 18, components 1602, 1604 and 1606 are identified by the message opcodes. Component IDs are discovered through the component routing table previously discussed. The IPC session manager routs incoming data to all the components that have subscribed to the IPC opcode in the message.

Quality of Service

Referring to FIG. 19, three channels, channel A 1902, channel B 1904 and channel C 1906 are shown having different data bandwidth and channel priorities. In this example, channel C 1906 has a higher priority than channel B 1904 and channel B 1904 has a higher priority than channel A 1902. Each channel 1902-1906 has a corresponding channel buffer 1910-1914 that is loaded with incoming data from each channel. An IPC scheduler 1916 located in the device interface layer of the IPC stack retrieves the incoming data packets from channel buffers 1910-1914 and forms them into an IPC frame 1918, taking into account the bandwidth and channel priorities of channels 1902-1906. The scheduler 1916 pulls the stored data from the channel buffers 1910-1914 in a scaled fashion at a data rate that is equivalent to the scaled IPC frame time, in order to smoothly transfer the data from the IPC channel buffers 1910-1914. The IPC frame time can vary depending on the IPC network's particular design requirements.

As was previously mentioned, any component wishing to participate in the IPC network must first register with the IPC stack and then request an IPC channel based on some QoS parameter(s). The QoS parameters can include but are not limited to channel priority, data rate, and other well known QoS parameters. The scheduler 1916 in the device layer is responsible for securing the data rate and the priority for channels. When a channel is granted, the device layer places the channel on a prioritized task. This means that a high priority channel will be guaranteed to be a high priority task in the device layer. The device layer can implement the channel priority as OS tasks with different priorities. This takes care of the channel priority of latency between software components sending data and the IPC scheduling of that data.

The scheduler 1916 plays the role of securing the data rate of each channel on the IPC link. It does this by going through each channel buffer in a round robin fashion (e.g., from high to low priority) and choosing (scaling to whatever an IPC frame is in time) enough data from each channel to accommodate the data rate that is assigned to that channel. If there is no data or not enough data, the next channel is given the difference of the unused data and so on. Thus, a combination of task priority and data rate scheduler, along with the concept of QoS per each software component provides the QoS technique in accordance with an embodiment of the invention.

In one embodiment of the invention, a channel having a certain QoS is only valid on the port where the component requested the QoS. For example, a certain data rate can be guaranteed only on a port such as a Synchronous Serial Interface (SSI) 1920 that a component such as a software thread 1922 has requested the QoS level from, but not on a Bluetooth link, since the Bluetooth link may change ports after QoS assignment.

Selective Broadcasting

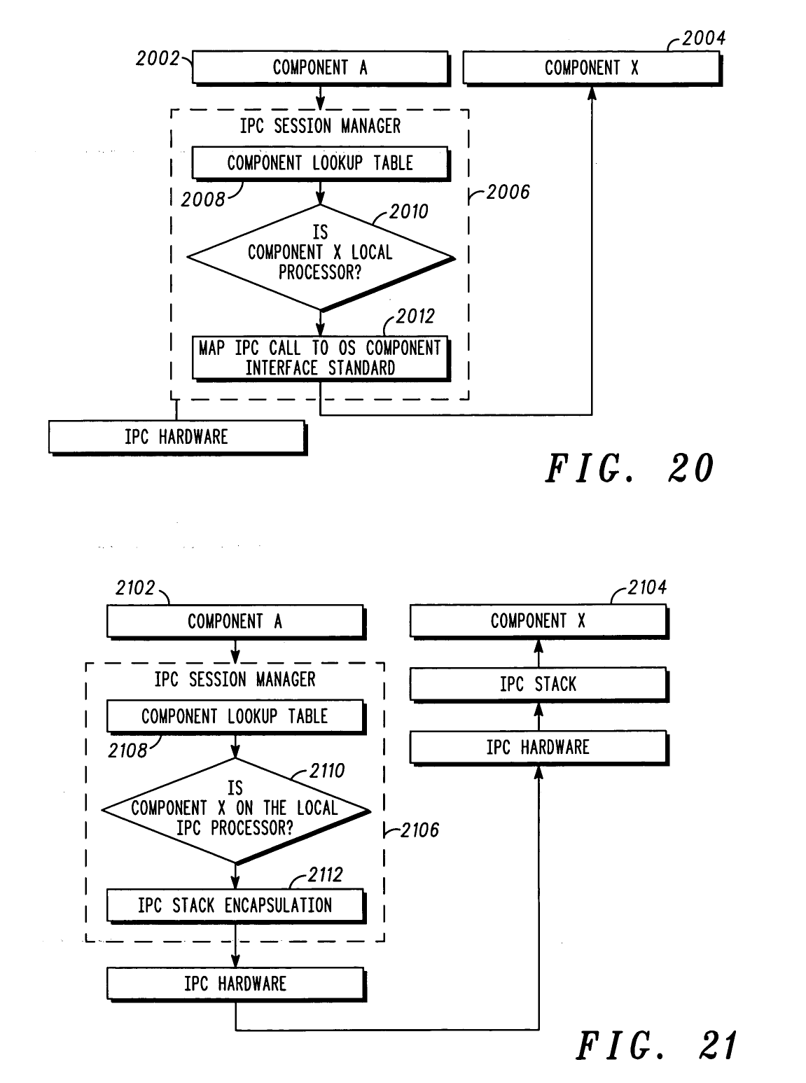

In FIG. 20, there is shown a diagram highlighting component-to-component messaging when two components 2002 and 2004 happen to be coupled to the same processor. In this illustrative example, component A 2002 sends component X 2004 a message using the IPC interface of the present invention. Component A 2002 does not need to know where component X 2004 is located, since that is the responsibility of the IPC session manager 2006. The IPC session manager 2006 keeps track of component ID assignment and component locations (components coupled to the processor). In this particular example, the session manager 2006 discovers from its database that component X 2004 is on the same processor with component A 2002.

Since component A 2002 and component X 2004 are located on the same processor, as determined by looking up the information on the IPC session manager's component lookup table 2008 in step 2010, the message does not undergo any IPC encapsulation, but instead it gets passed over to component X 2004 through the normal OS messaging call (e.g., Microsoft message queue). In step 2012 the IPC call is mapped to an OS interface standard. In this way, components such as components 2002 and 2004 do not have to worry about modifying their message input schemes. Components 2002 and 2004 do not have to change their message posting methodologies from an OS specific to an IPC call specific methodology, the proper routing of the messages is performed by the IPC stacks.

Referring now to FIG. 21, there is shown an illustrative example of component-to-component messaging when two components are coupled to different processors. In this example, component A 2102 does not reside on the same processor (not shown) as component X 2104, but on another processor. The IPC session manager 2106 will look up component X 2104 in the component lookup table 2108 and determine in step 2110 if the component X 2104 is located in the local processor. In this example, the session manager 2106 will determine that component X 2104 is not located in the local processor and will proceed to encapsulate the message in step 2112 with the appropriate header and other information. The message is then sent on the IPC network for delivery to component X 2104.

Referring now to FIG. 22, there is shown an IPC network that includes an IPC server 2202 such as a Windows CE™ AP, linked to a first client 2204 such as a modem BP and a second client 2206 such as a GSM BP. Located within server 2202 is a filtering table (also referred simply as filter) 2208 associated with the first client 2204 and a second filtering table 2210 associated with second client 2206. Coupled to the server 2202 is a component 2224 such as a software thread (e.g., audio). First client 2204 also includes a filtering table 2212 used to filter messages sent to components 2216 and 2218 and the second client 2206 has a filtering table 2214 used to filter messages sent to components 2220 and 2222. A client 2228 having a filtering table 2230 is shown daisy chained to client 2204. A component 2226 is shown coupled to client 2228.

Referring now to FIG. 23, there is shown the filtering table 2308 receiving a message having an opcode 2304 from component 2216. The filtering table 2308 is used to determine to which components/nodes the message needs to be forwarded to based on the opcode 2304. For example, for an audio application having an opcode of “0010” all those components associated with the opcode are forwarded the message. The selective broadcasting technique of the present invention allows for the filtering tables to be dynamically updated, allowing for clients to decide to whom messages are sent to within the IPC network.

In one embodiment of the invention, instead of using a combined component/node filtering table 2308 as shown in FIG. 23, separate tables are kept in each client and server. In this embodiment separate component filter tables and node filter tables are used, with the component and node filtering tables being present in every IPC node (client and server). This is true since clients such as client 2228 can forward a message directly to another client, such as client 2204 (clients 2228 and 2204 are daisy chained together). The node table in this example would link the nodes with the data types supported by the particular node and the component table would keep a list of the components for that client or server linked to a particular opcode.

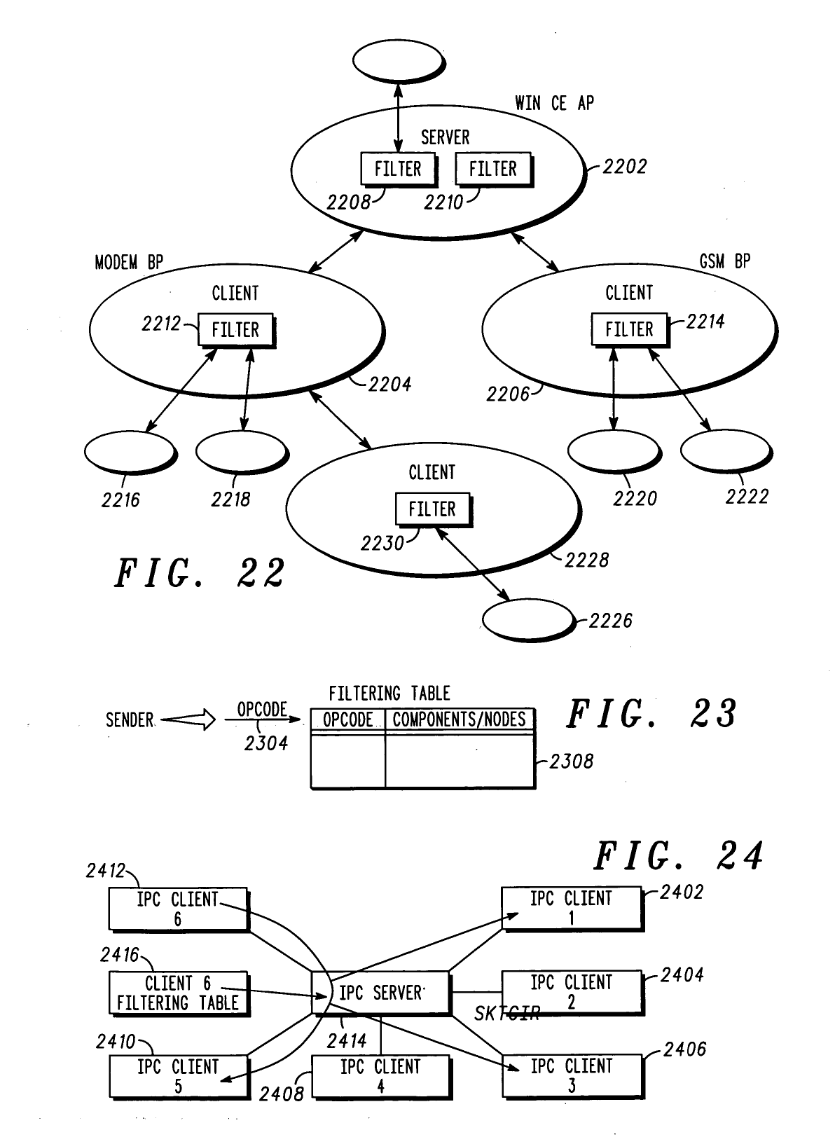

In FIG. 24, there is shown a diagram of a plurality of IPC clients 2402-2412 coupled to an IPC server 2414. In an example of selective broadcasting in accordance with an embodiment of the present invention, IPC client 2412 (IPC client 6) broadcasts a message over the IPC network using a filtering table assigned to IPC client 2412. Each client 2402-2412 will have an associated filtering table and the IPC server will have a filtering table used to select clients. In the illustrative example shown, a client 6 filtering table 2416 which is located in IPC server 2414 helps to selectively broadcasts the message to IPC client 2402 (IPC client 1), IPC client 2406 (IPC client 3) and IPC client 2410 (IPC client 5) upon receiving a message from IPC client 2412. In this example, the filtering table 2416 causes IPC client 2404 (IPC client 2) and IPC client 2408 (IPC client 4) not to receive the message.

Each IPC client will have a filtering table assigned to it and located within the IPC server 2414. The filtering table of each of the IPC clients 2402-2412 can be dynamically updated by the IPC nodes through the IPC link. This selective broadcasting feature allows an IPC client to send a message to selected targets by filtering out those IPC clients the message should not be sent to. The filter table 2416 allows for the ability to dynamically include any IPC client into the IPC data link for communications. Thus, an IPC network can be dynamically formed in this fashion without any compile time dependencies. The selective broadcasting feature provides for a dynamic method for software components to communicate with other software components on different IPC clients. The selective broadcasting feature allows the IPC clients not to be preconfigured in terms of fixed sets of dedicated IPC channels and dedicated bandwidths. The IPC stack and the hardware located below the stack are also abstracted such that components can choose different links to communicate, as they are required.

The IPC protocol allows for the dynamic addition of any IPC conforming MA into the IPC link for communication. Thus, an IPC network is formed without any compile time dependencies, or any other software assumptions. The IPC of the present invention presents a standard way for software components to communicate with the IPC stack and the hardware below the stack is also abstracted such that components can choose different links to communicate. The QoS and selective broadcasting features provide for improved IPC performance by allowing the clients and components to have improved flexibility.

While the preferred embodiments of the invention have been illustrated and described, it will be clear that the invention is not so limited. Numerous modifications, changes, variations, substitutions and equivalents will occur to those skilled in the art without departing from the spirit and scope of the present invention as defined by the appended claims.

1. An interprocessor communication (IPC) network, comprising:
an IPC client;
a component coupled to the IPC client;
an IPC server coupled to the IPC client, the IPC server including at least one filtering table for use in determining where a message sent by the component needs to be sent.

2. An IPC network as defined in claim 1, wherein messages from the component comprises opcode and the at least one filtering table uses the opcode to determine where the message sent by the component needs to be sent.

3. An IPC network as defined in claim 1, wherein the IPC client and the IPC server can negotiate the contents of the at least one filtering table.

4. An IPC network as defined in claim 2, wherein the at least one filtering table links the opcode to the component and any additional components that are associated with the opcode.

5. An IPC network as defined in claim 1, wherein the IPC client further comprises a filtering table.

6. An IPC network as defined in claim 5, wherein the filtering table located in the IPC client determines if messages should be received by the component.

7. An IPC network as defined in claim 6, further comprising a second component coupled to the IPC client wherein the filtering table in the client determines whether any of the first and second component coupled to the IPC client should receive a message sent to the IPC client.

8. An IPC network as defined in claim 1, wherein the IPC server further comprises a filter table for each IPC client coupled to the IPC server.

9. A method for providing selective broadcasting in an InterProcessor communications (IPC) network having an IPC client, an IPC server and a component coupled to the IPC client, the method comprising the steps of:
By the component, transmitting a message having an opcode;
receiving the message at the IPC server;
by the server, using a filter table associated with the IPC client to determine where the message needs to be directed.

10. A method as defined in claim 9, wherein the IPC client can negotiate with the IPC server regarding the contents of the filter table.

11. A method as defined in claim 9, wherein the filter table links the opcode with all other components coupled to the IPC network that are to receive messages sent by the component having the opcode.

12. A method as defined in 9, wherein the opcode is associated with a particular type of service.

13. An InterProcessor communications (IPC) network, comprising:
an IPC stack having a presentation manager, a IPC session manager and a device interface layer;
a component coupled to the IPC stack, the component being assigned a channel based on a Quality of Service (QoS);
an IPC scheduler coupled to the device interface layer; wherein
the IPC scheduler is responsible for providing the QoS assigned to the channel.

14. An IPC network as defined in claim 13, wherein the IPC scheduler secures a data rate required by the channel.

15. An IPC network as defined in claim 14, further comprising:
a channel buffer coupled to the channel, the channel buffer storing data that is to be sent via the channel.

16. An IPC network as defined in claim 15, wherein the IPC scheduler chooses enough data from the channel buffer to support the data rate required by the channel.

17. An IPC network as defined in claim 16, wherein the IPC scheduler scales the data that it picks from the channel buffer depending on a size of an IPC frame that is used by the IPC scheduler.

18. An IPC network as defined in claim 16, wherein the IPC scheduler chooses the data from the channel buffer depending on a priority level of the channel.

19. An IPC network as defined in claim 13, wherein the channel assigned to the component is based on a QoS level required by the component.

20. An IPC network as defined in claim 13, further comprising a port coupled to the component wherein the QoS is valid only when the component is using the port.
